(19) United States
(12) Patent Application Publication
(10) Pub. No.: US 2002/0084690 A1
(43) Pub. Date: Jul. 4, 2002

(54) Brake pedal feel emulator and method

(75) Inventors: James W. Zehnder II, Huber Heights, OH (US); John C. Layman, Trotwood, OH (US)

Correspondence Address: DELPHI TECHNOLOGIES, INC., Legal Staff, 1450 W. Long Lake, P.O. Box 5052 Mail Code: 482-204-450, Troy, MI, 48098, US

(73) Assignee: DELPHI AUTOMOTIVE SYSTEMS

(21) Appl. No.: 09/754,686

(22) Filed: Jan. 3, 2001

(51) Int. Cl. B60T 13/74

(52) U.S. Cl. 303/3

(57) ABSTRACT

A brake pedal feel emulator that produces a pedal characteristic not unlike conventional vacuum boosted or hydraulic brake systems. The system includes a master cylinder, a first and second piston slidably carried in the master cylinder, a gas-filled bellows emulator and a spring emulator operably attached to the master cylinder, and a reservoir carrier near the master cylinder. When a brake force is manually applied, a gas within gas-filled bellows compresses thereby generating a first stage of emulator travel. Once a pre-load force is surpassed, a coil spring within the spring emulator compresses thereby generating, along with the gas-filled bellows, a second stage of emulator travel. The two stages of emulator travel comprise a characteristic rate of pedal travel versus pedal force.

### TECHNICAL FIELD OF THE INVENTION

The present invention relates to a hydraulic brake system. One aspect of the invention relates to a device that emulates the pedal feel of a conventional vacuum boosted system wherein a multi-stage non-linear brake pedal travel versus brake pedal force characteristic is achieved.

### BACKGROUND OF THE INVENTION

Vehicle drivers have become accustomed to the “feel” of a brake pedal resistance that mirrors a manually applied braking force. Braking systems commonly known as brake-by-wire (BBW) or similar systems typically include a master cylinder that is isolated from the braking system. Such BBW systems rely on automatic electric or electric-hydraulic means to remotely activate the brake. Consequently, normal brake pedal “feel” would be absent due to isolation of the master cylinder. This has provided an impetus to develop a brake pedal actuator that has the “feel” of a resistance force coacting against the driver in a manner normally provided by manual apply systems.

A known device that mimics the conventional pedal feel when the master cylinder is isolated from the remainder of the braking system, similar to that provided by a vacuum boosted system, includes an elastomeric spring emulator that is integrated with the master cylinder. It has been determined that such a system is sensitive to temperature fluctuation and, thus, does not effectively produce a consistent pedal “feel” under some conditions. Alternatively, a system that relies on a bellows and coil spring emulator non-integral to the master cylinder may experience an undesirable pressure and pedal force dip during a spike apply of a brake pedal force, due to a line pressure drop.

Therefore, it would be desirable to achieve a brake pedal travel emulator whose pedal feel characteristic is relatively resistant to temperature changes, does not experience a pedal force dip, and is capable of emulating the “feel” of a conventional vacuum boosted system.

### SUMMARY OF THE INVENTION

One aspect of the invention provides a brake pedal emulator system comprising: a master cylinder, a first piston slidably positioned in the master cylinder, a second piston slidably positioned in the master cylinder, a reservoir carried near the master cylinder, a first seal operably attached to the first piston wherein a force applied to said first piston positions the first seal member to isolate the reservoir from the master cylinder, a second seal operably attached to the second piston wherein a force applied to said second piston positions the second seal member to isolate the reservoir from the master cylinder, a gas-filled bellows emulator operably attached to the master cylinder wherein isolation of the reservoir from said master cylinder diverts fluid pressure into said bellows emulator, and a spring emulator operably attached the master cylinder wherein isolation of the reservoir from said master cylinder diverts fluid pressure into said spring emulator. The gas-filled bellows emulator and the spring emulator are integral to and carried near the master cylinder. A first chamber is formed within a bore of the master cylinder between the first piston and the second piston and a second chamber is formed within said bore of the master between the first piston and the second piston.

The gas-filled bellows emulator is further comprised of: a bellows housing wherein said bellows housing is in communication with the first chamber through a bellows port formed therein, a bellows device contained within the bellows housing wherein said bellows device compresses upon a diverted fluid pressure from the first chamber, and a bellows cap attached to one end of the bellows housing. The spring emulator further is further comprised of: an emulator housing wherein said emulator housing is in communication with the second chamber through an emulator port formed therein, a coil spring positioned within the emulator housing, an emulator piston slidably positioned within the emulator housing wherein the diverted fluid pressure from the second chamber exerts a force upon said emulator piston and said emulator piston compresses the coil spring upon a brake pedal force exceeding a pre-load of said coil spring; and an emulator cap attached to one end of the emulator housing. The reservoir is further comprised of: a first bypass port wherein the reservoir communicates with the first chamber of the master cylinder through said first bypass port, a second bypass port wherein the reservoir communicates with the second chamber of the master cylinder through said second bypass port, and a non-pressurized hydraulic fluid wherein said fluid flows to the first chamber and to the second chamber before the first seal and the second seal slide beyond the first bypass port and the second bypass port of the master cylinder, respectively, and obstruct said flow.

Another aspect of the invention provides for a method of operating a brake pedal emulator system comprising: applying a brake pedal force that results in the movement of a first piston and a second piston slidably positioned in a master cylinder, compressing a gas within a gas-filled bellows emulator, compressing a coil spring housed within a spring emulator; and isolating a reservoir from the master cylinder wherein a fluid flow is diverted. In operation, the application of the brake pedal force results in a movement of the first and second pistons within the master cylinder and positioning a first seal and a second seal to isolate the reservoir from said master cylinder, respectively. The aforementioned isolation by the first seal results in diverted fluid pressure from the master cylinder into the gas-filled bellows emulator and produces a compression of the gas. The compression of the gas within the gas-filled bellows emulator generates a pedal force versus travel characteristic that comprises a first stage of emulator travel. The isolation by the second seal results in diverted fluid pressure from the master cylinder into the spring emulator producing a compression of the coil spring within the spring emulator after the brake pedal force exceeds the pre-load of the coil spring. The compression of the coil spring within the spring emulator and the simultaneous compression of the gas within the gas-filled bellows emulator generate a pedal force versus travel characteristic that comprises a second stage of emulator travel.

Yet another aspect of the invention provides for a method of generating a multi-stage reaction force comprising: generating a first stage of emulator travel, generating a second stage of emulator travel, and generating a fluid compression stage of emulator travel. The generation of the multi-stage reaction force is resistant to a pressure and pedal force dip during a spike application of a brake pedal force. The multi-stage reaction force is comprised of a combination of a bellows force and a spring force wherein the bellows force rate is variable and the spring force rate is constant. Furthermore, as the brake pedal force increases, a commensurate increase in the multi-stage reaction force produces a diminished rate of pedal travel versus pedal force.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a fragmentary cross-sectional view of one embodiment of a brake pedal emulator system; and

FIG. 2 is a graph of brake pedal force versus brake pedal travel for the system in FIG. 1.

### DETAILED DESCRIPTION OF THE PRESENTLY PREFERRED EMBODIMENT

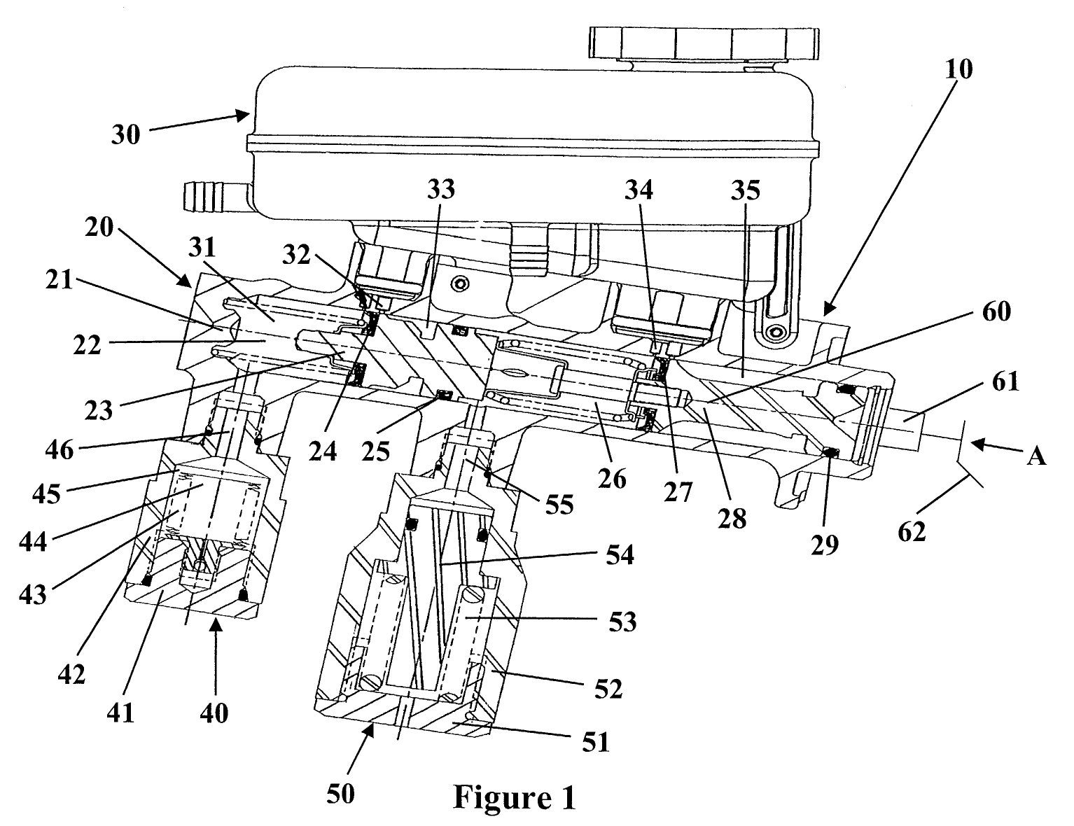

Referring to the drawings, illustrated in FIG. 1 is a brake pedal emulator system in accordance with the present invention designated in the aggregate as 10. The brake pedal emulator system includes a master cylinder 20 formed of an acceptably rigid material such as aluminum and an associated fluid reservoir 30. The brake pedal feel emulator system 10 is responsive to the manual application of a force A to a brake pedal 62, through a push rod 61.

A longitudinal central bore 60 extends through the master cylinder 20 and slidably carries a first piston 23 and a second piston 28 which are operably attached to one another and operably attached to the push rod 61. The push rod 61 exerts a force onto the first and second pistons 23, 28 proportionate to the brake pedal force A. A first chamber 22 is formed within the central bore 60 of the master cylinder 20 between the first piston 23 and a first end of the master cylinder body 21. A second chamber 26 is formed within the central bore 60 of the master cylinder 20 between the first piston 23 and the second piston 28. The first and second chambers 22, 26 are fluidly isolated from one another by a third seal 25. The reservoir 30 provides a non-pressurized gravitational flow of a hydraulic fluid 31 into the master cylinder 30 through both a first bypass port 32 and a second bypass port 34.

A first seal 24 is operably attached to the first piston 23 and fluidly isolates the first chamber 22 from the reservoir 30 upon sliding beyond the first bypass port 32. A second seal 27 is operably attached to the second piston 28 and fluidly isolates the second chamber 26 from the reservoir 30 upon sliding beyond the second bypass port 34. The third seal 25 and a fourth seal 29 fluidly isolate a first bypass chamber 33 and second bypass chamber 35, respectively. The seals 24, 25, 27, 29 are formed of an elastic compound such as rubber. Upon application of a brake pedal force A, the first and second piston 23, 28 slide toward the first end of the master cylinder 21 (as viewed in FIG. 1), resulting in the positioning of the first and second seals 24, 27 beyond the first and second bypass ports 32, 34, respectively. In the aforementioned position, the first and second chambers 22, 26 are fluidly isolated from the reservoir 30.

A gas-filled bellows emulator 40 is in communication with and shares a contiguous internal space, specifically a bellows space 45, with the first chamber 22. The gas-filled bellows emulator 40 is integral and attached to master cylinder 20. The fluid 31 is freely moveable within parts of both volumes 22, 45 through a bellows port 46 formed within a bellows housing 42. The gas-filled bellows emulator 40 is further comprised of a bellows device 43 that is filled with a gas 44 and a bellows cap 41 that seals one end of the bellows housing 42. Upon the isolation of the first chamber 22 from the reservoir 30, fluid 31 pressure is diverted into the bellows space 45. As the brake pedal force A increases, the fluid 31 pressure within the first chamber 22 and the bellows space 45 builds resulting in a compression of the gas 44 within the bellows device 43.

A spring emulator 50 is in communication with the second chamber 26 and is integral and attached to the master cylinder 20. The fluid 31 is freely moveable through an emulator port 55 formed within an emulator housing 52. The spring emulator 50 is further comprised of a steel coil spring 53 positioned within the emulator housing 52 between an emulator piston 54 and an emulator cap 51. The coil spring 53 is under a pre-load and provides a default force against the emulator piston 54. Upon the isolation of the second chamber 26 from the reservoir 30, fluid 31 pressure is diverted into a portion of the spring emulator 50. The fluid 31 pushes against the emulator piston 54, which in turn provides a force against the coil spring 53. As the brake pedal force A increases, the fluid 31 pressure within the second chamber 26 builds. When the fluid 31 pressure within the second chamber 26 exceeds the pre-load of the coil spring 53, the emulator piston 54 compresses said coil spring 53.

FIG. 1 depicts the embodiment in a state of zero brake pedal force A. In such a state, the fluid 31 flows freely by gravitational force from the reservoir 30 into the first and second chambers 22, 26 via the first and second bypass ports 32, 34. In operation, the application of a brake pedal force A to the brake pedal emulator system 10 results in the movement of the first and second pistons 23, 28 toward the first end of the master cylinder body 21. Any increase in fluid 31 pressure in the first and second chambers 22, 26 is dissipated into the reservoir 30 via the first and second bypass ports 32, 34, respectively. As the brake pedal force A increases, the first and second seals 24, 27 slide beyond the first and second bypass ports 32, 34. At this point, the fluid 31 flow from the reservoir 30 is shunted into the first and second bypass chambers 33, 35. In addition, the first and second chambers 22, 26 become fluidly isolated from the reservoir 30 and any fluid 31 pressure within said chambers 22, 26 cannot be dissipated via the first and second bypass ports 32, 34.

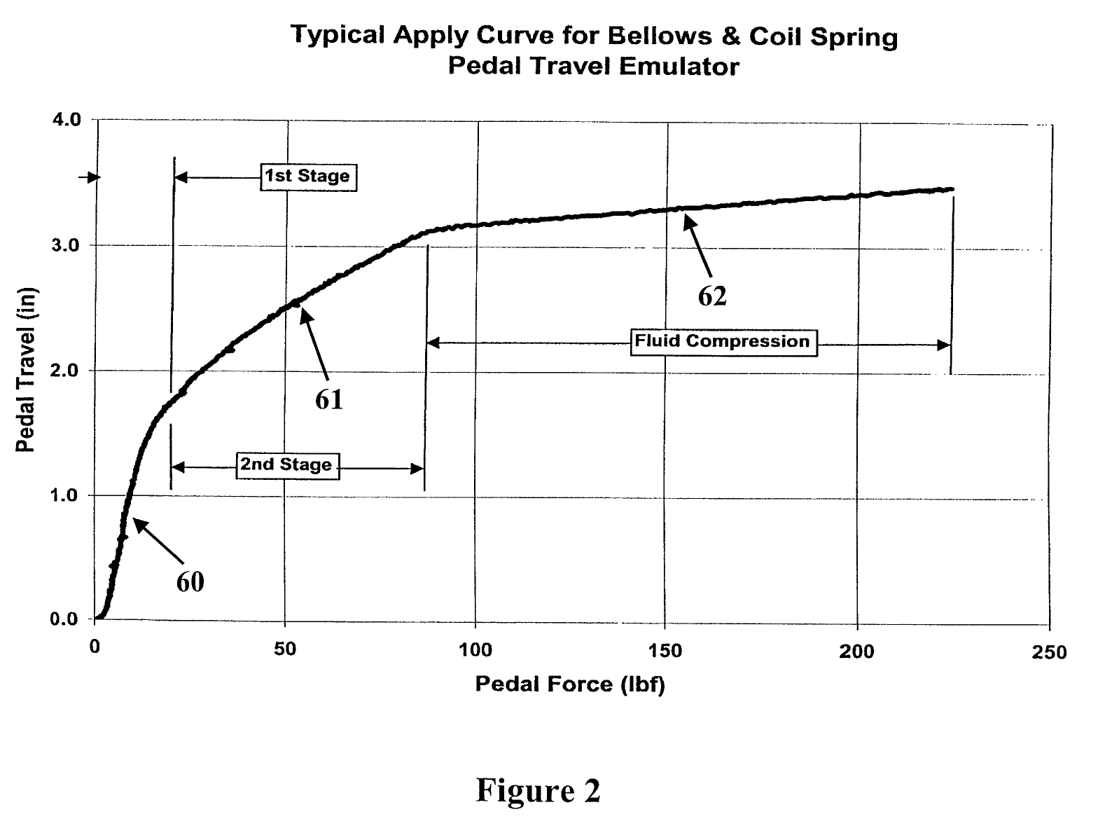

As the brake pedal force A continues to increase, the fluid 31 pressure within the first and second chambers 22, 26 increases. As a result, the fluid 31 pressure increase within the first chamber 22 is transmitted to the gas-filled bellows emulator 40 via the bellows port 46. The gas 44 within the bellows device 43 begins to compress providing a variable bellows force against the movement of the push rod 61. A non-linear brake pedal force A versus pedal travel characteristic results and comprises a first stage of emulator travel 60 depicted in FIG. 2.

During the initial compression of the bellows device 43, the fluid 31 pressure increase within the second chamber 26 is transmitted to the spring emulator 50 via the emulator port 55. The fluid 31 pushes against the emulator piston 54, which in turn provides a force against the coil spring 53. The coil spring 53 is initially under a pre-load and does not begin to compress until the force placed upon the emulator piston 54 exceeds said pre-load force. As the pressure continues to build within the second chamber 26, the emulator piston 54 begins to compress the coil spring 53 providing a linear spring force against the movement of the push rod 61. The spring force, in conjunction with simultaneous bellows force, produces a non-linear brake pedal force A versus pedal travel characteristic that comprises a second stage of emulator travel 61 depicted in FIG. 2. The coil spring 53 continues to compress until the emulator piston 54 contacts the emulator cap 51.

The brake pedal emulator system 10 produces a multi-stage reaction force at the brake pedal 62 wherein said force produces a characteristic pedal force A versus pedal travel. An experimental result of the presently preferred embodiment is graphically displayed in FIG. 2. The multi-stage reaction force is comprised of a combination of a bellows force and a spring force and is resistant to a pressure and pedal force dip during a spike application of the brake pedal force A due to the aforementioned integral design. The non-linear function is divided into the first stage of emulator travel 60 and the second stage of emulator travel 61. The first stage 60 is produced by the bellows force and the second stage 61 is produce by the combination of the bellows and spring forces. Once the bellows device 43 and the coil spring 53 are fully compressed, the fluid 31 begins to compress. The fluid 31 compression comprises a fluid compression stage of emulator travel 62 wherein a minimal pedal travel increase is observed. In sum, as the brake pedal force A increases, a commensurate increase in the multi-stage reaction force produces a diminished rate of pedal travel versus brake pedal force A.

The present invention allows for variations that permit a desirable multi-stage reaction force for various applications. For example, a spring with a different spring constant or pre-load force can be utilized in order to achieve a desirable spring force. Alternatively, any number or type of springs, polymer, metallic alloy, other biasing members or the like may be used to achieve the desired characteristic. The gas-filled bellows emulator 40 and the spring emulator 50 may be variably attached to the master cylinder 20 to allow alternate system packaging. Additionally, the pistons 23, 28 may be varied in number or position within the master cylinder 20 to produce a desired pedal response curve 60-62.

While the embodiment of the invention disclosed herein is presently considered to be preferred, various changes and modifications can be made without departing from the spirit and scope of the invention. The scope of the invention is indicated in the appended claims, and all changes that come within the meaning and range of equivalents are intended to be embraced therein.

1. A brake pedal feel emulator system comprising:
a master cylinder;
a first piston slidably positioned in the master cylinder;
a second piston slidably positioned in the master cylinder;
a reservoir carried near the master cylinder;
a first seal operably attached to the first piston wherein a force applied to said first piston positions the first seal member to isolate the reservoir from the master cylinder;
a second seal operably attached to the second piston wherein a force applied to said second piston positions the second seal member to isolate the reservoir from the master cylinder;
a gas-filled bellows emulator operably attached to the master cylinder wherein isolation of the reservoir from said master cylinder diverts fluid pressure into said bellows emulator; and
a spring emulator operably attached the master cylinder wherein isolation of the reservoir from said master cylinder diverts fluid pressure into said spring emulator.

2. The system of claim 1 wherein the gas-filled bellows emulator and the spring emulator are integral to and carried near the master cylinder.

3. The system of claim 1 wherein a first chamber is formed within a bore of the master cylinder between the first piston and the second piston and a second chamber is formed within said bore of the master between the first piston and the second piston.

4. The system of claim 1 wherein the gas-filled bellows emulator further comprise;
a bellows housing wherein said bellows housing is in communication with the first chamber through a bellows port formed therein;
a bellows device contained within the bellows housing wherein said bellows device compresses upon a diverted fluid pressure from the first chamber; and
a bellows cap attached to one end of the bellows housing.

5. The system of claim 1 wherein the spring emulator further comprise;
an emulator housing wherein said emulator housing is in communication with the second chamber through an emulator port formed therein;
a coil spring positioned within the emulator housing;
an emulator piston slidably positioned within the emulator housing wherein the diverted fluid pressure from the second chamber exerts a force upon said emulator piston and said emulator piston compresses the coil spring upon a brake pedal force exceeding a pre-load of said coil spring; and
an emulator cap attached to one end of the emulator housing.

6. The system of claim 1 wherein the reservoir further comprise;
a first bypass port wherein the reservoir communicates with the first chamber of the master cylinder through said first bypass port;
a second bypass port wherein the reservoir communicates with the second chamber of the master cylinder through said second bypass port; and
a non-pressurized hydraulic fluid wherein said fluid flows to the first chamber and to the second chamber before the first seal and the second seal slide beyond the first bypass port and the second bypass port of the master cylinder, respectively, and obstruct said flow.

7. A method of operating a brake pedal emulator system comprising;
applying a brake pedal force that results in the movement of a first piston and a second piston slidably positioned in a master cylinder;
compressing a gas within a gas-filled bellows emulator;
compressing a coil spring housed within a spring emulator; and
isolating a reservoir from the master cylinder wherein a fluid flow is diverted.

8. The method of claim 7 wherein the application of the brake pedal force results in a movement of the first piston within the master cylinder and positioning a first seal to isolate the reservoir from said master cylinder.

9. The method of claim 8 wherein isolating the reservoir from the master cylinder and resulting diverted fluid pressure from said master cylinder into the gas-filled bellows emulator produces a compression of the gas.

10. The method of claim 9 wherein the gas within a the gas-filled bellows emulator compresses thereby generating a pedal force versus travel characteristic that comprises a first stage of emulator travel.

11. The method of claim 7 wherein the application of the brake pedal force results in a movement of the second piston within the master cylinder and positioning a second seal to isolate the reservoir from said master cylinder.

12. The method of claim 11 wherein isolating the reservoir from the master cylinder and resulting diverted fluid pressure from said master cylinder into the spring emulator produces a compression of the coil spring.

13. The method of claim 12 wherein the coil spring within the spring emulator compresses after the brake pedal force exceeds the pre-load of the coil spring.

14. The method of claim 13 wherein the compression of the coil spring within the spring emulator and the simultaneous compression of the gas within the gas-filled bellows emulator generate a pedal force versus travel characteristic that comprises a second stage of emulator travel.

15. A method of generating a multi-stage reaction force comprising;
generating a first stage of emulator travel through a gas compression force;
generating a second stage of emulator travel through the bellows force and a spring force; and
generating a fluid compression stage of emulator travel.

16. The method of claim 15 wherein the gas compression force comprises a bellows force.

17. The method of claim 15 wherein the generation of the multi-stage reaction force is resistant to a pressure and pedal force dip during a spike application of a brake pedal force.

18. The method of claim 15 wherein the gas compression force rate is variable and the spring force rate is constant.

19. The method of claim 15 further comprising increasing a brake pedal force, increasing the multi-stage reaction force to produce a diminished rate of pedal travel versus pedal force.

20. A brake pedal feel emulator system comprising;
means for applying a brake pedal force that results in the movement of a first piston and a second piston slidably positioned in a master cylinder;
means for compressing a gas within a gas-filled bellows emulator;
means for compressing a coil spring housed within a spring emulator; and
means for isolating a reservoir from the master cylinder wherein a fluid flow is diverted.
